(19) United States
(12) Patent Application Publication
(10) Pub. No.: US 2016/0297032 A1
(43) Pub. Date: Oct. 13, 2016

(54) LASER PROCESSING SYSTEM WITH LIGHT EMITTING PART AND CONTROL APPARATUS MOVABLE TOGETHER

(71) Applicant: FANUC CORPORATION, Minamitsuru-gun (JP)

(72) Inventor: Hiroyuki Yoshida, Minamitsuru-gun (JP)

(73) Assignee: FANUC CORPORATION, Minamitsuru-gun (JP)

(21) Appl. No.: 15/092,060

(22) Filed: Apr. 6, 2016

(30) Foreign Application Priority Data
Apr. 9, 2015 (JP) 2015-080319

(51) Int. Cl. B23K 26/064; B23K 26/02

(52) U.S. Cl. CPC B23K 26/064; B23K 26/02

(57) ABSTRACT

A laser oscillator of a laser processing system includes a light emitting part for emitting a laser beam, a power source for supplying electric power to the light emitting part so as to emit a laser beam, and a laser controlling part for controlling the power source. Both the light emitting part and the laser controlling part are provided in a support structure, which is movable away from a laser processing apparatus, and are movable together with the support structure.

### BACKGROUND OF THE INVENTION

1. Field of the Invention

The present invention relates to a laser processing system using a laser beam emitted from a laser oscillator.

2. Description of the Related Art

A laser processing system using a laser beam is used for cutting or welding a sheet metal or laminate shaping or the like.

FIG. 5 shows an exemplary configuration of an existing laser processing system. A laser processing system 100 as illustrated includes a laser oscillator 200, a laser processing apparatus 300 using a laser beam emitted from the laser oscillator 200 to process a workpiece. The laser oscillator 200 is controlled by a laser control part 400 so as to obtain laser oscillation.

The laser processing apparatus 300 includes an actuation mechanism 310 for moving a workpiece horizontally and vertically, a mechanism controlling part 320 for controlling the actuation mechanism 310, and an amplifier 330 for supplying electric power to the actuation mechanism 310 in response to a control signal output from the mechanism controlling part 320. The laser processing apparatus 300 is configured to output from a processing head 340 a laser beam directed from the laser oscillator 200 through an optical fiber or a waveguide 350.

The laser processing system 100 operates so as to process a workpiece by emitting a laser beam from the processing head 340 onto the workpiece while moving the workpiece by way of the actuation mechanism 310. JP H06-190581 A discloses a laser processing apparatus having a configuration in which a laser oscillator and a processing head are coupled via an optical fiber or a waveguide.

In such a laser processing system 100, the laser oscillator 200 provided with a resonator and the like is generally installed in a different housing from the laser controlling part 400. The mechanism controlling part 320 is also accommodated in a housing of the laser processing apparatus 300. In order to perform laser processing, it is necessary to operate the mechanism controlling part 320 and the laser controlling part 400 in a synchronous manner, and therefore the mechanism controlling part 320 and the laser controlling part 400 are connected to each other by a signal cable 360. In addition, it is necessary to install an optical fiber or a waveguide over a long distance from the laser oscillator 200 up to the processing head 340.

In contrast, JP 2014-213341 A discloses a laser processing apparatus provided with a fiber laser oscillator, in which components of the fiber laser oscillator are arranged in multiple locations of a frame of the laser processing apparatus in a distributed manner. JP S63-273581 A discloses a laser processing system which includes an NC laser apparatus provided with a laser oscillator, a power source for driving the laser oscillator, and a numerical control apparatus integrally coupled to each other, and a processing table controlled by the numerical control apparatus of the NC laser apparatus.

In the above-described existing laser processing system 100, when an optical unit (e.g., a resonator) of the laser oscillator 200 malfunctions or deterioration of an optical unit occurs, the optical unit is removed from the laser oscillator 200, and replaced with a new one. In this process, since the laser controlling part 400 is provided in a different housing from the laser oscillator 200, it is not necessary to replace the laser controlling part 400.

On the other hand, after an optical unit is replaced, it is necessary to re-set control parameters unique to the optical unit, which makes maintenance or repair work (hereinafter may be simply referred to as “the repair work”) labor-intensive and time-consuming. Accordingly, there is a need for a laser processing system which can improve the efficiency of repair work on the laser oscillator.

### SUMMARY OF THE INVENTION

According to a first aspect of the invention, there is provided a laser processing system comprising: a laser oscillator; and a laser processing apparatus configured to process a workpiece by using a laser beam emitted from the laser oscillator, the laser processing apparatus comprising: an actuation mechanism configured to move the workpiece relative to the laser processing apparatus; and a mechanism controlling part configured to control the actuation mechanism, the laser oscillator comprising: a light emitting part configured to emit a laser beam; a power source configured to supply electric power to the light emitting part so as to emit a laser beam from the light emitting part; and a laser controlling part configured to control the power source; wherein the light emitting part and the laser controlling part are provided in a support structure which is movable away from the laser processing apparatus and are movable together with the support structure.

According to a second aspect of the invention, there is provided the laser processing system according to the first aspect, wherein the power source is further provided in the support structure and movable together with the support structure.

According to a third aspect of the invention, there is provided the laser processing system according to the first or second aspect, wherein the support structure further comprises a movable part which is movable independently of the support structure, and wherein at least one of the light emitting part, the power source, and the laser controlling part is provided in the movable part so as to be movable together with the movable part independently of the support structure.

According to a fourth aspect of the invention, there is provided the laser processing system according to any one of the first to third aspects, wherein the laser processing apparatus further comprises an amplifier configured to supply electric power to the actuation mechanism, and wherein the amplifier is provided in the support structure and movable together with the support structure.

According to a fifth aspect of the invention, there is provided the laser processing system according to the third aspect, wherein the laser processing apparatus further comprises an amplifier configured to supply electric power to the actuation mechanism, and wherein the amplifier is provided in the movable part and movable together with the movable part independently of the support structure.

According to a sixth aspect of the invention, there is provided the laser processing system according to any one of the first to fifth aspects, wherein the laser processing apparatus is a processing tool which comprises a plurality of tools being exchangeable, and wherein one of the plurality of tools is a processing head configured to output a laser beam emitted from the light emitting part.

According to a seventh aspect of the invention, there is provided the laser processing system according to any one of the first to sixth aspects, wherein the laser processing apparatus comprises a multiple-joint robot, wherein a processing head configured to output a laser beam emitted from the light emitting part is attached to a wrist of the multiple-joint robot, and wherein the support structure is provided in a housing accommodating a control apparatus configured to control the multiple-joint robot.

According to an eighth aspect of the invention, there is provided the laser processing system according to any one of the first to sixth aspects, wherein the support structure is provided in a housing of the laser processing apparatus.

According to a ninth aspect of the invention, there is provided the laser processing system according to any one of the first to eighth aspects, wherein the laser oscillator is a fiber laser oscillator.

According to a tenth aspect of the invention, there is provided the laser processing system according to any one of the first to ninth aspects, wherein the mechanism controlling part and the laser controlling part are configured by a common control apparatus.

These and other objects, features and advantages of the present invention will become more apparent in light of the detailed description of exemplary embodiments thereof as illustrated in the drawings.

### BRIEF DESCRIPTION OF THE DRAWINGS

FIG. 1 shows a laser processing system according to one embodiment.

FIG. 2 shows a configuration of a support structure in a laser processing system according to one embodiment.

FIG. 3 shows a configuration of a support structure in a laser processing system according to another embodiment.

FIG. 4 shows a laser processing system according to yet another embodiment.

FIG. 5 shows an existing laser processing system.

### DETAILED DESCRIPTION

Embodiments of the present invention will be described with reference to the accompanying drawings. Constituent elements of the illustrated embodiments may be modified in size in relation to one another, as necessary, for better understanding of the present invention. The same or corresponding constituent elements will be designated with the same referential sign.

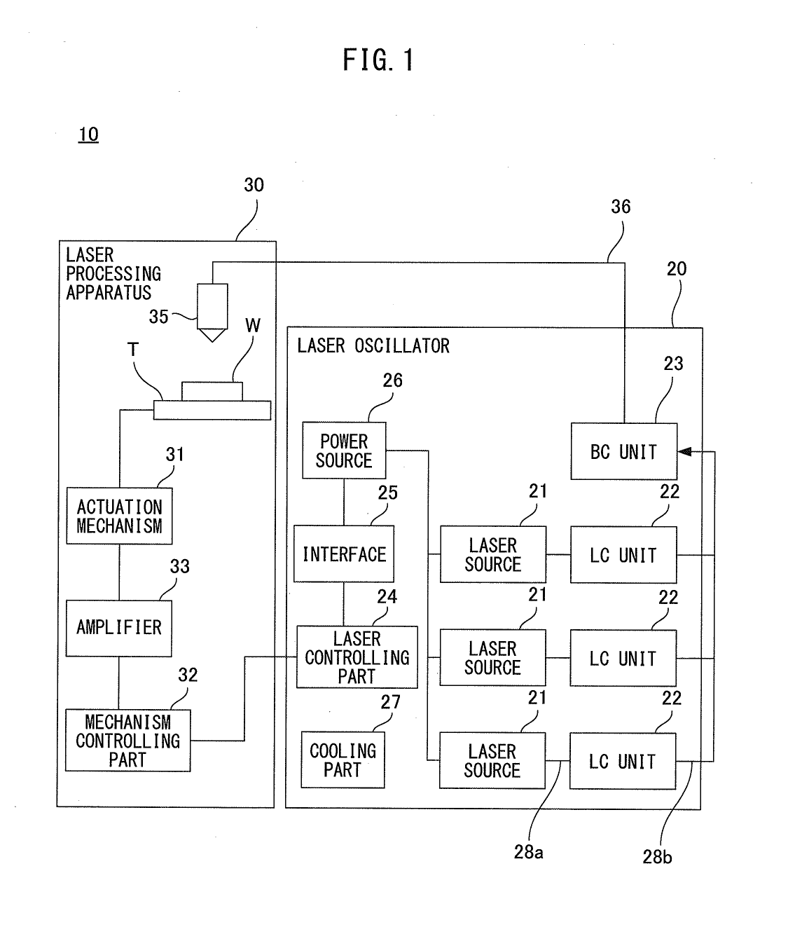

FIG. 1 shows an exemplary configuration of a laser processing system 10 according to one embodiment. A laser processing system 10 includes a laser oscillator 20 for emitting a laser beam, and a laser processing apparatus 30 for performing desired processing using the laser beam. The laser processing system 10 is used for cutting or welding a sheet metal, laminate shaping, or the like.

In an illustrated example, the laser processing apparatus 30 is used to process a workpiece W. The workpiece W is held at a table T which is driven by an actuation mechanism 31, for example, so as to move along an X-axis line, Y-axis line, and Z-axis line extending orthogonal to each other. The table T may also be provided with a chuck (not shown) which is designed to releasably hold the workpiece W. The chuck may also be driven by the actuation mechanism 31 in a similar manner as the table T.

The actuation mechanism 31 includes a motor (not shown) for applying mechanical power to a drive axis of the table T. The actuation mechanism 31 operates in response to a control signal from a mechanism controlling part 32. The mechanism controlling part 32 generates a command to the motor of the actuation mechanism 31 in accordance with a processing program. An amplifier 33 supplies an electric current to the motor of the actuation mechanism 31 in response to the command output from the mechanism controlling part 32. Since such a function and configuration of the laser processing apparatus 30 is known in the art, a detailed explanation thereof will be omitted herein.

The laser processing apparatus 30 is configured to output laser from a processing head 35 connected to the laser oscillator 20 through an optical fiber or waveguide 36. The processing head 35 is provided with an optical element such as a collimator lens or a condensing lens.

According to one embodiment, the laser oscillator 20 is a fiber laser oscillator using an optical fiber as a resonator. In the following explanation, the laser oscillator 20 configured as a fiber laser oscillator will be described by way of example, other types of laser oscillators may also be employed. For example, the laser oscillator 20 may be a direct diode laser apparatus configured to direct a laser beam emitted from a semiconductor laser apparatus to an optical fiber through a condensing optical system and to the processing head connected to the opposite end of the optical fiber. The laser oscillator 20 may be a gas laser apparatus designed to emit a laser beam as a result of excitation discharge using CO₂ gas or the like, which serves as a medium. In the case where the laser oscillator 20 is configured as a direct diode laser apparatus or a gas laser apparatus, the laser oscillator 20 may also be configured direct a laser beam to a processing point with the aid of other optical systems, other than an optical fiber.

The laser oscillator 20 includes laser sources 21, a plurality of laser cavity units (hereinafter may be referred to as “the LC unit”) 22, a beam combiner unit (hereinafter may be referred to as “the BC unit”) 23, a laser controlling part 24, an interface 25, a power source 26, and a cooling part 27.

The laser source 21 is a laser apparatus for emitting a laser beam in response to a control signal from the laser controlling part 24. According to one embodiment, the laser source 21 may be a semiconductor laser apparatus, but is not limited thereto. The laser beam emitted from the laser source 21 is directed to the LC unit 22 through an optical fiber 28a.

The LC unit 22 includes an optical fiber made of ytterbium-doped (Yb-doped) or erbium-doped (Er-doped) quartz, as an excitation medium, serving as a resonator. The laser beam is amplified by the LC unit 22 and directed to the BC unit 23 through an optical fiber 28b. Referring to FIG. 1, three LC units 22 are illustrated, but the laser processing system 10 may include any number of LC units 22.

The BC unit 23 combines the laser beams directed respectively from the LC units 22 through the optical fibers 28b. The laser beam combined by the BC unit 23 is introduced into a feeding fiber 36 extending up to the processing head 35 of the laser processing apparatus 30. Since the function and the configuration of the fiber laser oscillator is known in the art, a detailed explanation thereof will be omitted herein.

The laser controlling part 24 cooperates with the mechanism controlling part 32 of the laser processing apparatus 30 to generate a command for controlling operation of the laser source 21 which serves as an excitation source of the laser oscillator 20.

The interface 25 is configured from an electric circuit having a known configuration and mounted on a printed board, processing signals input from the laser controlling part 24 to the power source 26.

The power source 26 supplies electric power to the laser source 21 in response to the command from the laser controlling part 24 to generate a laser beam.

The cooling part 27 dissipates heat generated from a heat source such as the laser source 21 or the power source 26. The cooling part may have a known configuration or, for example, may be a cooling fun, or a cooling system including a pipe through which cooling liquid is circulated.

Referring to the block diagram of FIG. 1, the laser controlling part 24 and the mechanism controlling part 32 are illustrated separately for the sake of convenience, but may be configured as a single control apparatus. For example, the functions of the laser controlling part 24 and the mechanism controlling part 32 may be realized by the same digital computer having a common hardware configuration such as a CPU, RAM, ROM, and the like.

According to the present embodiment, a light emitting part of the laser oscillator 20 (the laser source 21, the LC units 22, the BC unit 23, and the like) for emitting a laser beam, the power source 26 for supplying excitation power to the light emitting part, and the laser controlling part 24 for controlling the laser oscillator 20 are provided on a support structure movable from the laser processing apparatus 30. In other words, the light emitting part, the power source 26 and the laser controlling part 24 can be moved away from the laser processing apparatus 30, together with the support structure.

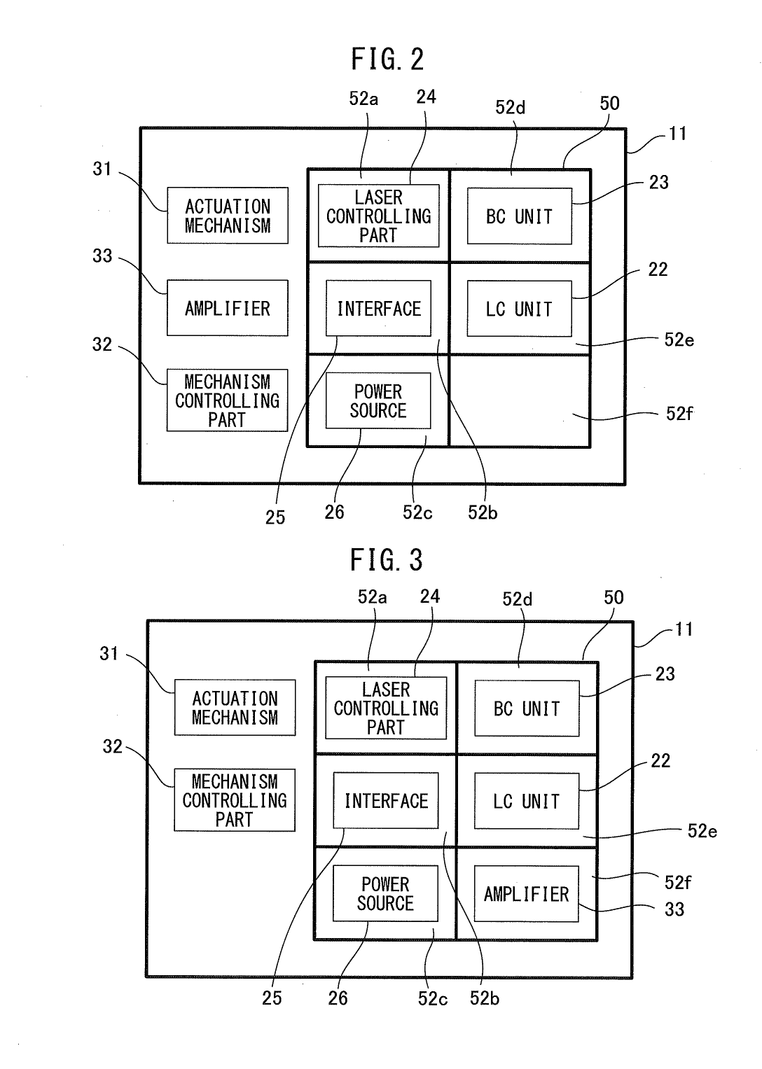

FIG. 2 shows components of a laser oscillator 20 provided in a support structure 50 in a laser processing system 10 according to one embodiment. The support structure 50 is accommodated in a housing 11 of the laser processing system 10 together with the laser processing apparatus 30. The support structure 50 also has a plurality of movable parts 52a to 52f. The movable parts 52a to 52f are movable together with the support structure 50, while can be moved independently of the support structure 50, if necessary.

According to one embodiment, the movable parts 52a to 52f are releasably locked to the support structure 50. This allows the movable parts 52a to 52f to move together with the support structure 50 in a locked state, whereas the movable parts 52a to 52f can move independently of the support structure 50 in a released state. In the illustrated embodiment, components of the laser oscillator 20, such as the LC units 22, BC unit 23, the laser controlling part 24, and the like, are separately provided so as to be selectively and individually taken out from the support structure 50.

According to one embodiment, the support structure 50 may be in the form of cabinet with casters. The movable parts 52a to 52f may also be configured, for example, as a drawer which is slidable between a retracted position and an extended position.

As such, the laser processing system 10 according to the present embodiment, the light emitting part of the laser oscillator 20 including the resonator is provided on the support structure 50 together with the laser controlling part 24 for controlling the laser oscillator 20, so as to be able to move together. This allows the light emitting part to be taken out together with the power source 26 and the laser controlling part 24 for the replacement, when a component of the light emitting part, such as the LC unit 22, malfunctions, by moving the support structure 50 away from the laser processing apparatus 30.

This is advantageous over the case where the only light emitting part of the laser oscillator is replaced. In order to accurately control the laser oscillator 20 by the laser controlling part 24, it is necessary to set control parameters unique to the individual light emitting part. The control parameters include a coefficient used for adjustment of the command to the power source 26, based on a relationship between an electric current value input from the power source 26 and a laser output in response thereto. The control parameters may also include coefficients for adjusting measurement values of various sensors, such as an output sensor, a temperature sensor, or the like.

In the case where the light emitting part of the laser oscillator 20 and the laser controlling part 24 can be removed and replaced together, the process of setting the control parameters can be omitted at the repair site, and the efficiency can be improved, since the light emitting part and the laser controlling part 24 for which the control parameters are set in advance can be prepared for the replacement.

In addition, according to the present invention, various components of the laser oscillator 20 are provided in the movable parts 52a to 52f of the support structure 50, and therefore, the required components can be selectively taken out for the repair, thereby increasing the efficiency.

According to the embodiment in which the laser oscillator 20, the laser controlling part 24, and the laser processing part 30 are accommodated in the same housing, it is unnecessary to install a plurality of housings, and therefore the space required for installing the laser processing system 10 can be reduced.

According to the embodiment in which the laser oscillator 20 is accommodated in a housing of the laser processing apparatus 30, a length of the feeding fiber 36 connecting the BC unit 23 of the laser oscillator 20 and the processing head 35 can be shortened.

According to the embodiment in which the laser controlling part 24 and the mechanism controlling part 32 are configured by a common control apparatus, the configuration of the laser processing system 10 can be simplified. In addition, it is unnecessary to install a signal cable used to synchronize the laser controlling part 24 and the mechanism controlling part 32.

FIG. 3 shows the configuration of a support structure 50 in a laser processing system according to another embodiment. The configuration according to the present embodiment is the same as the embodiment shown in FIG. 2, except that the amplifier 33 of the laser processing apparatus 30 is provided in the movable part 52f of the support structure 50.

In the present embodiment, the amplifier 33 of the laser processing apparatus 30 is movable away from the laser processing apparatus 30 and together with the support structure 50 or the movable part 52f. Since the amplifier 33 and the actuation mechanism 31 are connected to each other by a power cable or a signal cable (not shown) which can be easily deformed, it is unnecessary to disconnect the amplifier 33 and the actuation mechanism 31 when the amplifier 33 is taken out. This facilitates the repair of the amplifier 33.

It should be noted that in the embodiment in which the mechanism controlling part 32 and the laser controlling part 24 are configured by a common computer, the mechanism controlling part 32 is provided in the movable part 52a of the support structure 50 together with the laser controlling part 24.

According to yet another embodiment, the laser processing system 10 may also be provided with a generic processing tool configured to perform various processing as necessary for intended use. The processing tool includes a tool used for turning, milling, or the like. Such a tool is configured so as to be easily replaced with the processing head 35 configured to output a laser beam emitted from the laser oscillator 20, or switched the processing head 35 with the tool, or vice versa, when the processing tool is in operation.

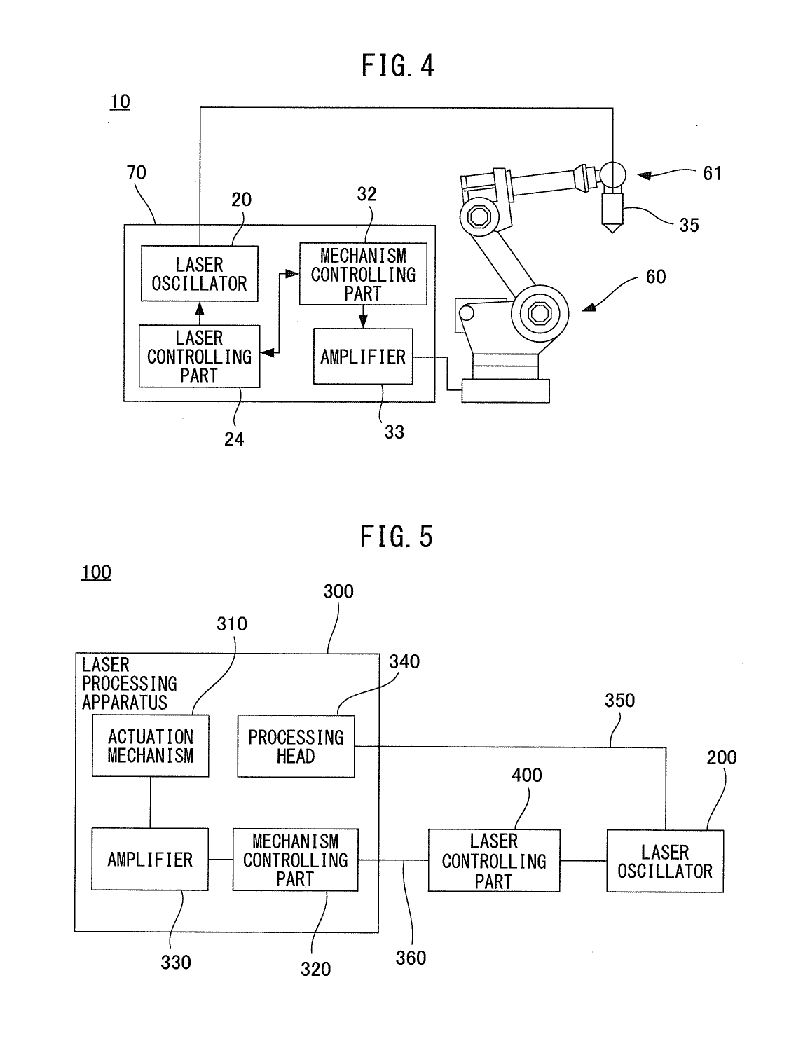

FIG. 4 shows a laser processing system 10 according to yet another embodiment. The laser processing system 10 of the present embodiment includes a multiple-joint robot 60. The robot 60 is provided with at its wrist 61 a processing head 35 which outputs a laser beam emitted from the laser oscillator 20. The robot 60 includes a motor at each of the joints and each motor is controlled by the mechanism controlling part 32 such that the processing head has a desired position and posture.

According to the present embodiment, the laser oscillator 20 and the laser controlling part 24 are accommodated in a housing 70 of a controller used for controlling the robot 60, in which a switching board is also accommodated. Also in such an embodiment, the light emitting part of the laser oscillator 20 and the laser controlling part 24 are provided in a support structure which is movable within the housing 70, and therefore, the same advantageous effect can be achieved as in the above-described embodiments.

### EFFECT OF THE INVENTION

According to the laser system of the present invention, the light emitting part of the laser oscillator and the laser controlling part are provided in a support structure which is movable away from the laser processing apparatus. Thus, the light emitting part and the laser controlling part can be easily replaced entirely for the repair. In order to accurately control the laser oscillator, it is necessary to set control parameters unique to the light emitting part in the laser controlling part. However, according to the present invention, the light emitting part and the laser controlling part can be taken out and replaced together, thereby eliminating the need to set the control parameters at the repair site and increasing the efficiency of the repair.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it would be apparent to a person skilled in the art that the present invention can be implemented by any combination of features of the embodiments either explicitly or implicitly disclosed herein.

1. A laser processing system comprising:
a laser oscillator; and
a laser processing apparatus configured to process a workpiece by using a laser beam emitted from the laser oscillator,
the laser processing apparatus comprising:
an actuation mechanism configured to move the workpiece relative to the laser processing apparatus; and
a mechanism controlling part configured to control the actuation mechanism,
the laser oscillator comprising:
a light emitting part configured to emit a laser beam;
a power source configured to supply electric power to the light emitting part so as to emit a laser beam from the light emitting part; and
a laser controlling part configured to control the power source;
wherein the light emitting part and the laser controlling part are provided in a support structure which is movable away from the laser processing apparatus and are movable together with the support structure.

2. The laser processing system according to claim 1, wherein the power source is further provided in the support structure and movable together with the support structure.

3. The laser processing system according to claim 1, wherein the support structure further comprises a movable part which is movable independently of the support structure, and wherein at least one of the light emitting part, the power source, and the laser controlling part is provided in the movable part so as to be movable together with the movable part independently of the support structure.

4. The laser processing system according to claim 1, wherein the laser processing apparatus further comprises an amplifier configured to supply electric power to the actuation mechanism, and wherein the amplifier is provided in the support structure and movable together with the support structure.

5. The laser processing system according to claim 3, wherein the laser processing apparatus further comprises an amplifier configured to supply electric power to the actuation mechanism, and wherein the amplifier is provided in the movable part and movable together with the movable part independently of the support structure.

6. The laser processing system according to claim 1, wherein the laser processing apparatus is a processing tool which comprises a plurality of tools being exchangeable, and wherein one of the plurality of tools is a processing head configured to output a laser beam emitted from the light emitting part.

7. The laser processing system according to claim 1, wherein the laser processing apparatus comprises a multiple-joint robot, wherein a processing head configured to output a laser beam emitted from the light emitting part is attached to a wrist of the multiple-joint robot, and wherein the support structure is provided in a housing accommodating a control apparatus configured to control the multiple-joint robot.

8. The laser processing system according to claim 1, wherein the support structure is provided in a housing of the laser processing apparatus.

9. The laser processing system according to claim 1, wherein the laser oscillator is a fiber laser oscillator.

10. The laser processing system according to claim 1, wherein the mechanism controlling part and the laser controlling part are configured by a common control apparatus.
